(19) United States
(12) Patent Application Publication
(10) Pub. No.: US 2026/0014972 A1
(43) Pub. Date: Jan. 15, 2026

(54) LOW POWER FAIL-SAFE BRAKING FOR AUTONOMOUS MOBILE ROBOTS

(71) Applicant: Ati Motors Inc., Milpitas, CA (US)

(72) Inventors: Venkata Hanuma Sai Teja Tiruvallur, Bengaluru (IN); Sagar Hanumantha, Bengaluru (IN); Ritesh Khatavkar, Belagavi (IN)

(73) Assignee: Ati Motors Inc., Milpitas, CA (US)

(21) Appl. No.: 18/772,074

(22) Filed: Jul. 12, 2024

(51) Int. Cl. B60T 13/74; B60T 13/66

(52) U.S. Cl. CPC B60T 13/741; B60T 13/662; B60T 2270/414

(57) ABSTRACT

According to an embodiment of the present disclosure, mechanical low power fail-safe brake designed for Autonomous Mobile Robots (AMRs) is described herein. The primary function of this brake is to provide braking and position-holding capabilities for the robot in the event of a power failure or power-off condition. The present disclosure provides the brake system to significantly reduce power consumption, while maintaining comparable torque output. The lower power consumption of this brake contributes to enhanced energy efficiency and extended operational capabilities for AMRs, allowing them to conserve power resources and perform tasks reliably in challenging environments.

### TECHNICAL FIELD OF THE INVENTION

This invention in general relates to autonomous mobile robots, and specifically to fail-safe breaking in autonomous mobile robots.

### Background

Material movement in industrial environments using trolleys can be automated using self-driving robotic vehicles. However, such automated vehicles still rely on manual interaction at the start and destination, e.g., to load or unload material, to check vehicle state, to charge or replace a vehicle battery, etc.

Autonomous mobile robots (AMRs) are commonly employed in manufacturing industries and warehouses to transport materials between locations without the need for a driver. The onboard computer of the AMR detects obstacles and makes braking decisions.

During the traversal of ramps (upward/downward slopes), the AMR alternates between using brakes and throttle control. Typically, the onboard computer is powered by a primary battery source, which also actuates the motors and brakes. However, in the event of a power failure, there is a need for a mechanism to disengage the motor and engage the brake. While this can be accomplished using a secondary power source, it lacks redundancy in cases of hardware failure.

In existing “Always-on” braking solutions, the brakes get automatically engaged in the absence of a primary power source. Such braking systems are also referred to as fail-safe brakes. When the AMR is in usage, power is needed to continually disengage the fail-safe brakes. Current Fail-safe braking systems require a significant amount of power to disengage the brake system. This in turn, reduces the endurance of the robotic vehicle. In turn, the robot would have to be frequently decommissioned for charging or be fitted with a larger battery pack to compensate for the braking loss.

### SUMMARY OF THE INVENTION

Mechanical fail-safe brake designed for Autonomous Mobile Robots (AMRs). The primary function of this brake is to provide braking and position-holding capabilities for the robot in the event of a power failure or power-off condition. Existing braking systems consume a considerable amount of power, to achieve the desired holding torque. In contrast, the brake system disclosed herein has been developed to significantly reduce power consumption, e.g., operating at less than for example 25% typical power while maintaining comparable torque output. The lower power consumption of this brake contributes to enhanced energy efficiency and extended operational capabilities for AMRs, allowing them to conserve power resources and perform tasks reliably in challenging environments.

Disclosed herein is a Fail-Safe Braking (FSB) system that consumes only a fraction of the power needed.

The proposed Fail-Safe Braking (FSB) system has triple redundancy built in-first-level EM braking powered by a primary battery source, failing which a secondary battery source kicks in. The mechanical fail-safe brake is the overarching redundancy system that is activated upon the failure of either power source.

The proposed Fail-Safe Braking (FSB) system is designed to be concise because the holding torque requirements are considerably lower than traditional systems. As a result, the system can be retrofitted in AGVs and AMRs with space constraints.

The proposed Fail-Safe Braking (FSB) system is highly modular. This ensures that the design can be scaled to be fitted in AGVs and AMRs with varying payload requirements.

### BRIEF DESCRIPTION OF THE DRAWINGS

The foregoing summary, as well as the following detailed description of the invention, is better understood when read in conjunction with the appended drawings. For illustrating the invention, exemplary constructions of the invention are shown in the drawings. However, the invention is not limited to the specific components disclosed herein. The description of a component referenced by a numeral in a drawing is applicable to the description of that component shown by that same numeral in any subsequent drawing herein.

FIG. 1A illustrates normal vehicle operation on a ramp when the primary power source is present, in accordance with some implementations.

FIG. 1B illustrates fail-safe brakes being engaged on a ramp when the primary power source is detected to be off, in accordance with some implementations.

FIG. 2 illustrates an example sequence of events when power turns off, in accordance with some implementations. It also illustrates an example sequence of events upon resumption from a power-off scenario, in accordance with some implementations.

FIGS. 3A, 3B, 3C and 3D illustrate different views of a fail-safe braking system, in accordance with some implementations.

FIG. 4 illustrates a manual lever that can be used to override a fail-safe braking system, in accordance with some implementations.

FIG. 5 illustrates sub-modules of a fail-safe braking system, in accordance with some implementations.

FIG. 6 illustrates an overview of a fail-safe braking system, in accordance with some implementations.

FIG. 7 illustrates a swing arm setup for a fail-safe braking system, in accordance with some implementations.

FIG. 8 illustrates an example limit switch and electromagnet for a fail-safe braking system, in accordance with some implementations.

FIG. 9A-9C illustrates an example sequence of actions on a peck of a fail-safe braking system when the power goes off, in accordance with some implementations.

### DETAILED DESCRIPTION OF THE INVENTION

The presently disclosed subject matter now will be described more fully hereinafter with reference to the accompanying figures, in which some, but not all embodiments of the inventions are shown. Like numbers refer to like elements throughout. The presently disclosed subject matter may be embodied in many different forms and should not be construed as limited to the embodiments set forth herein; rather, these embodiments are provided so that this disclosure will satisfy applicable legal requirements. Indeed, many modifications and other embodiments of the presently disclosed subject matter set forth herein will come to mind to one skilled in the art to which the presently disclosed subject matter pertains having the benefit of the teachings presented in the foregoing descriptions and the associated figures. Therefore, it is to be understood that the presently disclosed subject matter is not to be limited to the specific embodiments disclosed and that modifications and other embodiments are intended to be included within the scope of the appended claims.

Self-driving vehicles offer many advantages-reduction in expense owing to saving labor costs; suitability for operation in tight spaces where conventional, manually-driven vehicles cannot operate; flexibility in design of shape; etc. Self-driving vehicles can operate in both indoor and outdoor environments. The vehicle and associated systems described herein can achieve autonomous movement in limited mapped environments such as private industrial spaces, warehouses, etc.

In an autonomous mobile robot (AMR) or other self-driving vehicle, data from sensors such as a light detection and ranging sensor (LiDAR) and one or more other sensors such as a camera, radar, etc. can be used to accurately detect objects and landmarks in an environment, for e.g., trolley, ramps, speed humps, gangways, storage racks, automation accessories such as trolley hitch, conveyors.

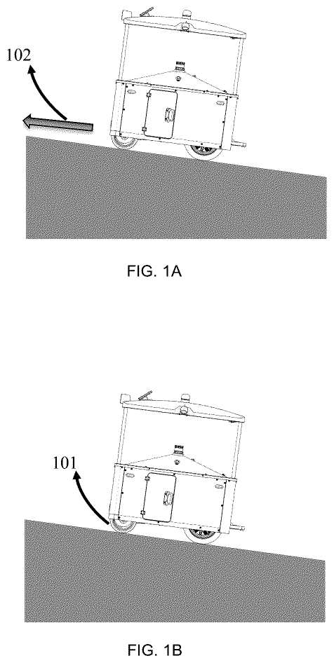

FIG. 1A illustrates normal vehicle operation on a ramp when the primary power source is present, in accordance with some implementations. As illustrated in FIG. 1A, the vehicle is in motion 102 and the fail-safe braking system is disengaged. The external lights (green) on the vehicle indicate that the vehicle is in motion.

FIG. 1B illustrates fail-safe brakes being engaged on a ramp, e.g., when the primary power source of the vehicle (e.g., a battery) is detected to be off, in accordance with some implementations. As illustrated in FIG. 1B, the vehicle is not in motion and the wheels 101 are stationary and held in place on the ramp by a fail-safe braking system (fail-safe brake). The external lights (red) on the vehicle indicate that the vehicle is stopped.

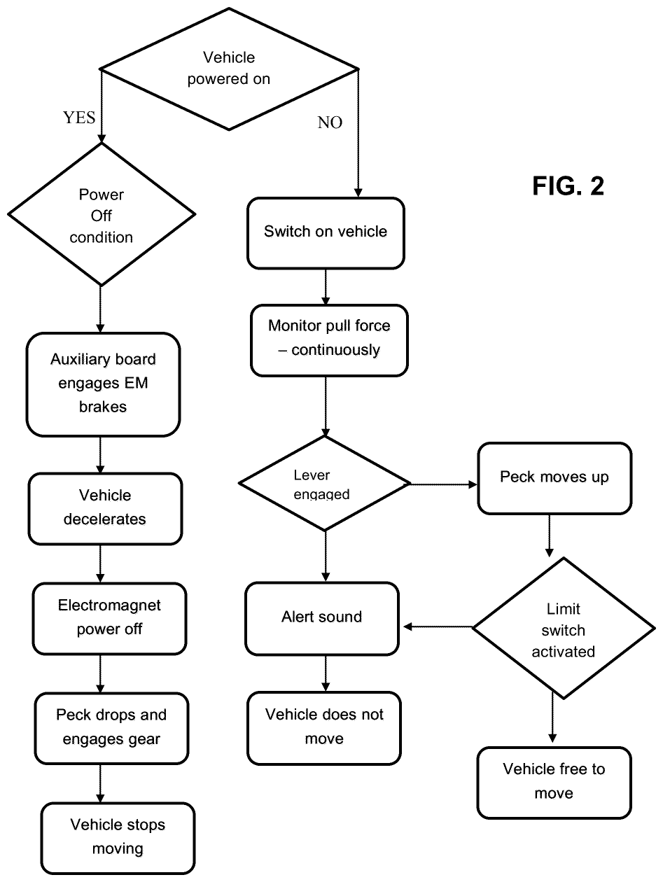

FIG. 2 illustrates an example sequence of events when power turns off, in accordance with some implementations. When the primary power source goes off, braking is automatically activated using an auxiliary power source. The auxiliary power source may be a small battery, ultracapacitor, or another power storage device. After a pre-configurated delay, the auxiliary power turns off and a fail-safe brake of the vehicle is automatically engaged. With this braking operation, the vehicle motion is stopped. Auxiliary braking retards the vehicle and reduces the requirements from the design of the fail-safe brake (since the fail-safe brake is not required to retard the vehicle). Without the use of the auxiliary brake, the power needed to disengage the fail-safe brake can be high, whereas the auxiliary brake enables a lower-power configuration of the fail-safe brake.

FIG. 2 also illustrates an example sequence of events upon resumption from a power-off scenario, in accordance with some implementations. When power is restored, a manual release lever is operated (by a human operator) to release the fail-safe brake. Upon release of the brake, the vehicle can resume motion, e.g., up the ramp with the power source supplying power.

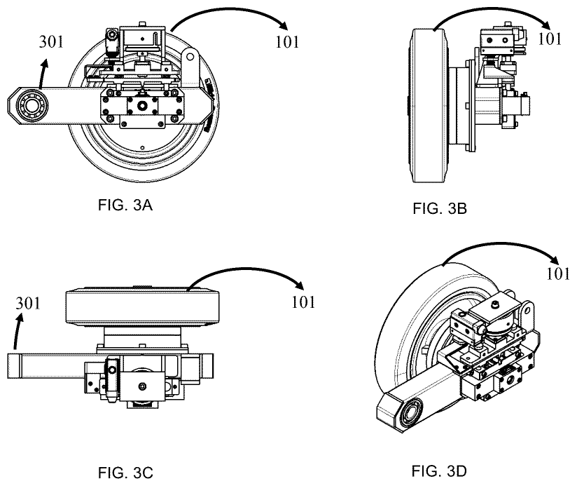

FIGS. 3A, 3B, 3C and 3D illustrates different views of a fail-safe braking system, in accordance with some implementations, comprising a swing arm 301. The front, top, side views are shown and illustrate the integration of the fail-safe braking system with wheels of the AMR.

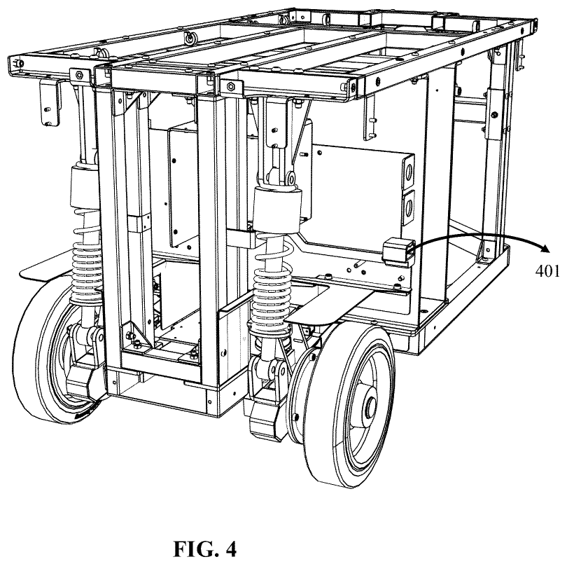

FIG. 4 illustrates a manual lever 401 that can be used to override a fail-safe braking system, in accordance with some implementations. As illustrated by the upward pointing arrow, the fail-safe braking system can be manually disengaged by moving the lever 401 in an upward direction.

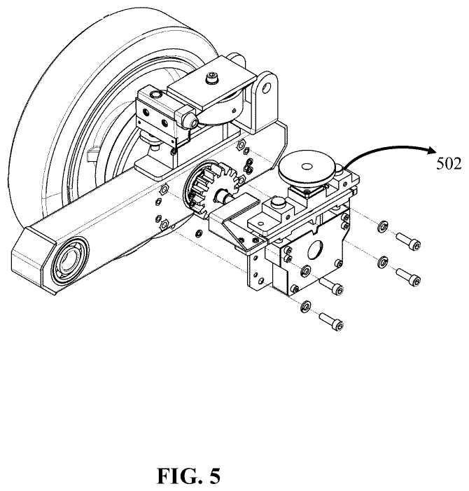

FIG. 5 illustrates sub-modules of a fail-safe braking system, in accordance with some implementations.

A swing-arm and regular electromechanical brakes are shown. Further, an electromagnet and limit-switch sub-system are shown. These provide fail-safe braking functionality in the event of power loss of the vehicle.

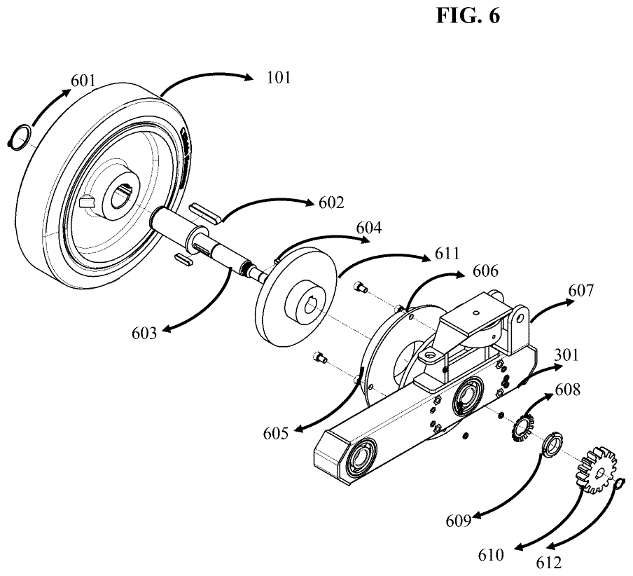

FIG. 6 illustrates an overview of a fail-safe brake system, in accordance with some implementations. The components labeled in the FIG. 6 are as follows:

External retaining ring 601 holds shaft and bore assemblies in place. The wheel 101 comprises a tyre.

Key Way 602, 603, 604 each represent a keyway or key slot on the wheel shaft that allows for alignment and connection between the shaft and the wheel assembly.

Electromechanical brakes are powered by the primary power source. The auxiliary power source can also engage these brakes for a short duration

A brake rotor 611 is responsible for generating friction and facilitating the braking action.

A brake stator 605 works in conjunction with the brake rotor to enable effective braking by creating the necessary magnetic field.

The fail-safe brake includes a swing arm 301 mechanism. The swing arm 301 is attached to the chassis of the vehicle which allows the swing arm 301 and the front wheel to move up and down with the undulations of the terrain.

A nut 609, e.g., a KM4 NUT, is used in the assembly rake fail-safe braking system to secure the swing arm 301 onto the shaft. A lock washer 608 is used to prevent unintentional loosening of the nut.

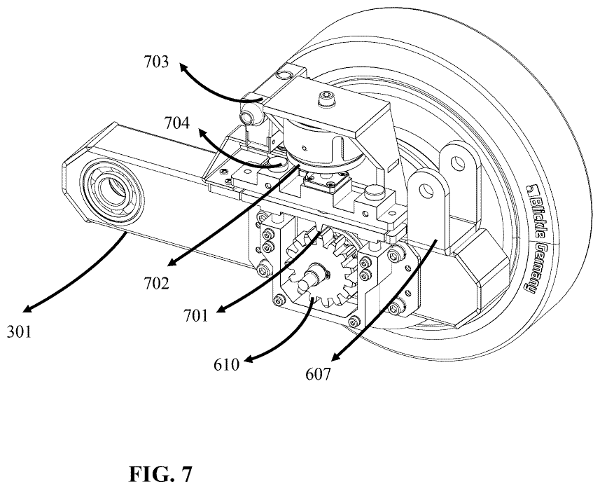

A fail-safe brake (FSB) gear 610 connects the rotary shaft to the place where a peck 701 gets locked. The peck 701 is automatically engaged during a power-off event that triggers the fail-safe braking system. An example peck 701 is described below with reference to FIG. 7.

An external retaining ring 612—This component functions as an external retaining ring, securing specific parts of the Fail-Safe Brake system in place.

A wheel shaft (14) connects the wheel assembly of the autonomous mobile robot to the rest of the structure of the robot.

FIG. 7 illustrates a swing arm setup for a fail-safe braking system, in accordance with some implementations. The swing arm setup includes a peck 701, a gear 510, an electromagnet 702, compression springs 704, a limit switch 703, and a swing arm 201.

Peck 701 is a locking mechanism that engages with a gear 610. It securely locks into the gear 610, preventing rotation. The gear 610 is attached to the shaft (as shown in FIG. 6) and acts as a connection point for transmitting rotational motion. The gear 610 engages with the peck 701, allowing the lock and release of the system.

An electromagnet 702 is utilized to hold the peck plate in place. When activated, the electromagnet 702 generates a magnetic force that secures the peck 701 in its locked position.

Springs 704 are compressed when the fail-safe brake is engaged. With the braking system activated, the compressed springs exert a force that locks the peck securely into the gear, ensuring a reliable braking action.

A limit switch 703 serves as a sensor to detect the status of the peck 701, indicating whether the peck is locked or unlocked. This information is utilized for the reliable functioning and monitoring of the fail-safe brake system.

The swing arm 301 provides structural support and integration of the components within the autonomous mobile robot.

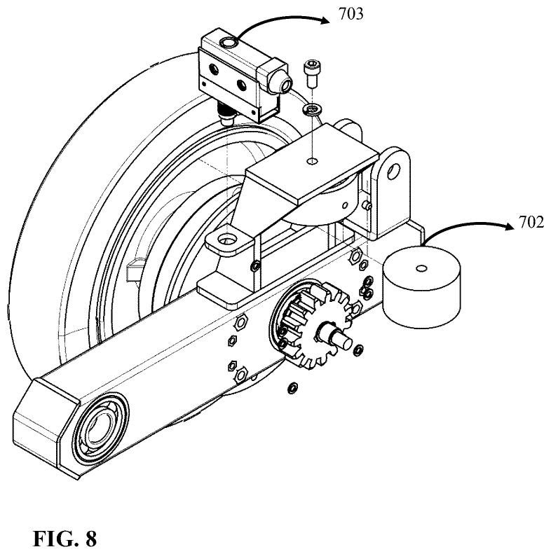

FIG. 8 illustrates an example of a limit switch and electromagnet for a fail-safe braking system, in accordance with some implementations.

Limit switch 703 serves as a sensor to detect the status of the peck, indicating whether it is locked or unlocked. The limit switch 703 is used for monitoring and controlling the fail-safe braking mechanism. An electromagnet 702 works in conjunction with the limit switch 703. The electromagnet 702 is responsible for generating a magnetic field that influences the position of the peck.

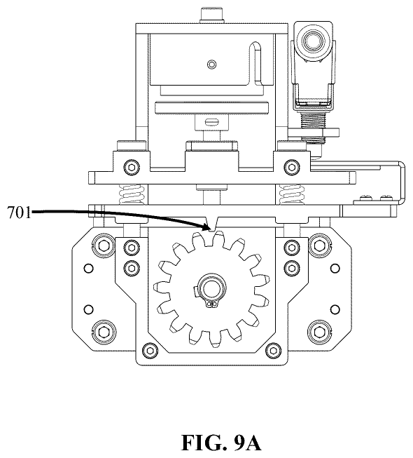

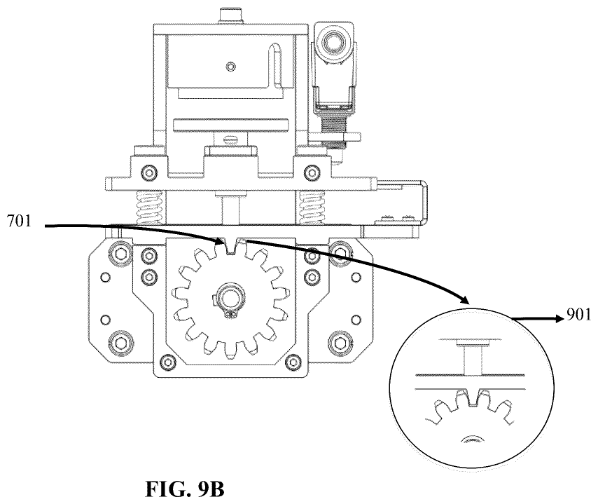

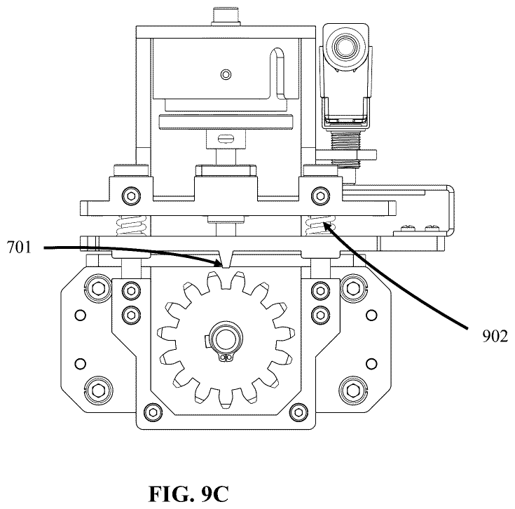

FIG. 9A-9C together illustrate an example sequence of actions on a peck 701 of a fail-safe braking system when the power goes off, in accordance with some implementations.

As shown in FIG. 9A, the peck 701 is released when the electromagnet power is cut off during a power-OFF event. As shown in FIG. 9B, the peck becomes engaged with the gear, 901, therefore the movement of the shaft is locked. This keeps the vehicle stationary even though there is no power source active. As shown in FIG. 9C, the peck 701 is released when the mechanical lever is lifted. This ensures that the vehicle is free to move.

The fail-safe braking system as described herein can be integrated with an autonomous mobile robot (AMR), an automated guided vehicle (AGV) or tugger (e.g., to which one or more trolleys can be attached for movement). An example AMR is shown in FIGS. 1A and 1B. FIG. 1A illustrates the brake in a disengaged position. FIG. 1B illustrates the brake in an engaged position. The entire fail-safe braking mechanism is integrated with the swing arm assembly, as described with reference to FIG. 7. By default, the peck 701 is in lock position as shown in FIG. 9B when the vehicle is stationary and power-OFF. The vehicle needs to supply power to disengage the brakes, move the peck up, and can then start moving.

At the time of a power-ON event, the primary battery source of the vehicle (AMR/AGV) is active. This in turn powers on a computer (e.g., on-board the vehicle) as well as the controls for motors and regular brakes. Upon sensing the primary power source, the limit switch 703 is engaged. In turn, the electromagnet 702 is powered on. This releases the peck 701 from the default lock position (shown in FIG. 9B). The electromagnet holds the peck in disengaged position and releases the gear 610. This enables the vehicle to move.

There are two distinct workflows triggered by power events, illustrated in FIGS. 2A and 2B.

When the primary power source is inactive, it is a power-OFF event. The electromagnet is not active in this condition. The springs 704 are compressed when the fail-safe brake is engaged. The compressed springs exert a force that locks the peck securely into the gear 610, ensuring a reliable braking action. FIG. 9A shows how the peck with a single tooth locks back into the gear. The peck profile can be carefully mated with the gear profile to ensure the reliable braking action. The limit switch 703 helps to monitor and hold the peck position.

An auxiliary brake controller board is applied to safely hold the vehicle in order to prevent the damage when the vehicle's main battery goes out of charge.

The auxiliary brake controller board is designed to stop the vehicle when the main battery is depleted, particularly on ramps. An auxiliary-brake enable button prevents the operator from accidentally turning on the vehicle without the auxiliary braking function. The auxiliary brake controller board monitors the main battery's presence and voltage level. If the main battery is completely drained, the auxiliary brake controller board will power the electromagnetic (EM) brakes using the auxiliary battery, providing an additional backup (for e.g., vehicle can be held stationary for 30-minutes assuming the auxiliary battery is at least 85% charged). A siren is also attached to indicate the absence of the main battery. The siren will be activated after a pre-configured timeout (for e.g., 12 seconds) after detecting the absence of the main battery or the start of auxiliary braking.

A fail-safe brake board is applied to safely hold the vehicle electrically and to safely stop the vehicle mechanically, in order to prevent the damage when the vehicle's main battery goes out of charge.

The fail-safe brake board safely stops the vehicle when the main battery is depleted, especially on ramps, and includes several failsafe checks. An auxiliary-brake enable button prevents the operator from accidentally turning on the vehicle without the auxiliary braking function. The failsafe brake board monitors the main battery's presence and voltage level. If the main battery is completely drained, the failsafe brake board will supply power to the electromagnetic (EM) brakes and solenoid coils using the auxiliary battery for example for 12 seconds. For example, after 12 seconds, the board will cut off the supply to the brakes, and the mechanical brakes will engage. A siren is attached to indicate the absence of the main battery, activating approximately 12 seconds after detecting the absence of the main battery if the vehicle hasn't been mechanically braked. The auxiliary-brake enable button can also be used to disable the mechanical braking, allowing the vehicle to be moved manually for service operations.

While transitioning between a power-ON event and a power-OFF event, the vehicle can be at maximum pulling capacity and/or maximum linear speed. If the brakes are engaged suddenly, it can result in significant wear and tear on the peck's teeth. Higher tensile strength of the peck and higher class gear (with more mating teeth) can add significant cost to the design. In addition, the power penalty for holding the brake in disengaged position increases as the peck strength increases. To obtain an efficient power-performance tradeoff, a switching system is described herein.

Step 1: An auxiliary brake board detects power-OFF condition and retards the vehicle using the regular electromechanical brake. Simultaneously, the cut-off of power to the electromagnet of the fail-safe braking system is delayed.

Step 2: The electromagnet is powered off. The vehicle comes to a halt.

The delay configuration in the auxiliary braking board is a careful trade-off between the vehicle deceleration when running at cruise speed and drawing maximum pull force, and tensile strength of the peck and gear complexity required for the fail-safe braking system.

Engaging the braking system using the auxiliary power source provides a tertiary safety redundancy. For instance, mechanical failure to hold the peck in place keeps the limit switch engaged, which in turn keeps the electromechanical brakes engaged.

Further, a manual override to disengage the brake is provided, as described with reference to FIG. 4. The manual override is operable even in power-OFF condition. The manual lever is provided at an ergonomically convenient location in the AMR (or other vehicle that uses the fail-safe braking system as described herein). Actuation of the fail-safe brake is routed through levers internally. The peck position continues to be released when the mechanical lever is lifted, as shown in FIG. 9C.

The manual override serves several important purposes: (a) manual validation post a sudden power-OFF event; (b) enables parking the AMR on a ramp; (c) enables servicing the AMR while it is stopped on a ramp.

The foregoing examples have been provided merely for explanation and are in no way to be construed as limiting of apparatus disclosed herein. While the apparatus has been described with reference to particular embodiments, it is understood that the words, which have been used herein, are words of description and illustration, rather than words of limitation. Furthermore, although the apparatus has been described herein with reference to particular means, materials, and embodiments, the apparatus is not intended to be limited to the particulars disclosed herein; rather, the design and functionality of the apparatus extends to all functionally equivalent methods, structures and uses, such as are within the scope of the appended claims. While particular embodiments are disclosed, it will be understood by those skilled in the art, having the benefit of the teachings of this specification, that the apparatus disclosed herein is capable of modifications and other embodiments may be effected and changes may be made thereto, without departing from the scope and spirit of the apparatus disclosed herein.

1. A low power consuming fail-safe braking system for a vehicle, comprising:
i. primary power source;
ii. auxiliary power source;
iii. a swing arm setup, further comprising:
fail-safe brake gear that connects a rotary shaft to a position where a peck gets locked, wherein the peck is automatically engaged during a power-off event that triggers the fail-safe braking system, and wherein when primary power source goes off, braking using peck engagement with a brake gear is automatically activated using said auxiliary power source;
a gear attached to a shaft and that acts as a connection point for transmitting rotational motion;
said peck is a locking mechanism that engages with said gear, securely locking into the gear and preventing rotation, whereby the gear engages with the peck, allowing the lock and release of the system;
an electromagnet that holds a peck plate in place, wherein when the electromagnet is activated, it generates a magnetic force that secures the peck in its locked position;
springs that are compressed when the fail-safe brake is engaged, wherein when the braking system is activated, compressed springs exert a force that locks the peck securely into the gear, ensuring a reliable braking action;
limit-switch subsystem further comprising:
a. limit switch that serves as a sensor to detect the status of the peck, indicating whether the peck is locked or unlocked, wherein the limit switch is used for monitoring and controlling the fail-safe braking mechanism;
b. said electromagnet that works in conjunction with the limit switch, and the electromagnet is responsible for generating a magnetic field that influences the position of the peck;
iv. external retaining ring that holds shaft and bore assemblies in place;
v. keyway or key slot on the wheel shaft that allows for alignment and connection between the shaft and the wheel assembly;
vi. electromechanical brakes powered by said primary power source;
vii. a brake rotor that generates friction and facilitates the braking action;
viii. a brake stator that works in conjunction with said brake rotor to enable effective braking by creating the necessary magnetic field;
ix. a manual release lever that is operated to release the fail-safe brake when said primary power source is restored;
wherein when the primary power source is inactive, it is a power-OFF event and the electromagnet is not active, the springs are compressed when the fail-safe brake is engaged, and the compressed springs exert a force that locks the peck securely into the gear and wherein the limit switch monitors and hold the peck position;
wherein the peck is in lock position when the vehicle is stationary and the vehicle is in power-OFF stage, and the vehicle needs to supply power to disengage the brakes, move the peck up, and to move the vehicle;
and wherein at the instance of a power-ON event, the primary battery source of the vehicle is active, the primary battery turns power on a computer and the controls for motors and regular brakes, whereafter, upon sensing the primary power source, said limit switch is engaged and said electromagnet is powered on, resulting in the release of the peck from a default lock position and enables the vehicle to move.

2. The low power consuming fail-safe braking system of claim 1, wherein fail-safe braking system can be manually disengaged by moving the manual release lever in an upward direction.

3. The low power consuming fail-safe braking system of claim 1, further comprising a wheel shaft that connects a wheel assembly of the autonomous mobile robot to the rest of the structure of the robot.

4. A method of achieving fail-safe braking of a vehicle with efficient power performance, comprising the steps of:
detecting a power-OFF condition with an auxiliary brake board and retarding the vehicle using an electromechanical brake;
powering off an electromagnet and halting the vehicle;
implementing a delay configuration in an auxiliary braking board as a trade-off between the vehicle deceleration when running at cruise speed and drawing maximum pull force, and tensile strength of the peck and gear complexity required for the fail-safe braking system;
engaging brake(s) using an auxiliary power source thereby providing a tertiary safety redundancy, wherein mechanical failure to a peck in place keeps the limit switch engaged, which in turn keeps the electromechanical brakes engaged;
providing a manual override to disengage the brake, wherein the manual override is operable even in power-OFF condition, and a manual lever is provided, and actuation of a fail-safe brake is routed through levers internally, and the peck position continues to be released when the mechanical lever is lifted.

5. The low power consuming fail-safe braking system of claim 1, comprising an auxiliary brake controller board applied to safely hold the vehicle in order to prevent damage when the vehicle's main battery goes out of charge.

6. The low power consuming fail-safe braking system of claim 1, wherein an auxiliary brake controller board stops the vehicle when the main battery is depleted.

7. The low power consuming fail-safe braking system of claim 1, wherein an auxiliary enable button prevents an operator from accidentally turning on the vehicle without an auxiliary braking function.

8. The low power consuming fail-safe braking system of claim 1, wherein an auxiliary brake controller board monitors the main battery's presence and voltage level.

9. The low power consuming fail-safe braking system of claim 1, wherein an auxiliary brake controller board sends out alert to the operator regarding the depletion of the primary battery and emergency stoppage via the auxiliary power source.
